(19) United States
(12) Patent Application Publication
(10) Pub. No.: US 2025/0124836 A1
(43) Pub. Date: Apr. 17, 2025

(54) INSPECTION APPARATUS FOR DEFECT DETECTION AND MANUFACTURING METHOD OF ORGANIC LIGHT-EMITTING DEVICE

(71) Applicant: CANON KABUSHIKI KAISHA, Tokyo (JP)

(72) Inventor: YUJI HARA, Tokyo (JP)

(21) Appl. No.: 18/912,745

(22) Filed: Oct. 11, 2024

(30) Foreign Application Priority Data
Oct. 17, 2023 (JP) 2023-178906

(51) Int. Cl. G09G 3/00; G06T 5/20; G06T 7/00; G06T 7/62; G06V 10/46; G06V 10/75; G09G 3/3208

(52) U.S. Cl. CPC G09G 3/006; G06T 5/20; G06T 7/0008; G06T 7/62; G06V 10/46; G06V 10/751; G09G 3/3208; G06T 2207/20032; G06T 2207/30121; G06V 2201/07

(57) ABSTRACT

An inspection apparatus for defect detection in a display device having an array of a plurality of pixels, includes a processor; and a memory storing a program which, when executed by the processor, causes the inspection apparatus to: an image acquisition processing to acquire an image of the pixels of the display device with sensor pixel; a locating processing to locate positions of defect candidates of the display device in the image captured by the image acquisition processing; a contour generation processing to generate a contour of the defect candidate of the display device based on the position of the defect candidate of the display device; and a determination processing to determine whether the defect candidate is a defect of the display device based on a perimeter of the contour.

### BACKGROUND OF THE INVENTION

### Field of the Invention

The present invention relates to an inspection apparatus for defect detection in display devices such as micro-OLEDs, and more particularly to an inspection apparatus for detection of defects from captured images of display devices.

### Description of the Related Art

With the increase in pixel density of solid-state imaging devices such as large CMOS sensors in recent years, an inspection method for high pixel-density displays has been proposed, in which images of the display device that is the inspection target captured with a high pixel-density sensor camera are analyzed by a defect detection program. Images to be inspected are captured with an extended exposure time or a long-duration shutter speed. If the sensor contains more pixels with a dark current defect than a tolerable number of defective pixels that can be corrected by the pixel defect correction feature mounted in the camera, the sensor pixel defects due to dark current appear as pixels with an abnormal value in the image being inspected. This may cause the defect detection program to erroneously determine such pixels as defects of the display panel.

Japanese Patent Application Publication No. H8-201228 proposes a sensor defect correction technique, in which a dark frame of the inspection target panel is obtained as pixel defect data in advance and stored in a memory, to be subtracted from the image captured during the inspection.

The technique according to Japanese Patent Application Publication No. H8-201228 involves the processes of acquiring and storing sensor defect data, and requires a memory for storing the data, which increases the test time and number of constituent elements of the inspection system. When inspecting a display panel by displaying several types of images, in particular, (e.g., images of white, red, green, and blue colors), it is necessary to prepare defect data for each image, because the imaging conditions (such as exposure time) differ for each image.

Display panels of the recent years have higher resolution, and the pixel density of camera sensors has accordingly increased, which complicates the issues associated with the preparation of defect data. Moreover, RTS (random telegraph signal) noise in sensor outputs, which appears as bright dots (defective sensor pixels having a higher value than surrounding pixels) either in the image being inspected or in defect data, cannot be corrected. When this noise appears in the defect data, it may result in a pseudo dark dot (defective sensor pixel having a lower value than surrounding pixels) due to excessive subtraction by a pixel value during defect correction using the defect data.

### SUMMARY OF THE INVENTION

The present invention was made in view of the above circumstances and it is an object of the invention to provide an inspection apparatus that is able to detect a defect in a display device without using sensor defect data.

According to some embodiments, an inspection apparatus for defect detection in a display device having an array of a plurality of pixels, includes a processor; and a memory storing a program which, when executed by the processor, causes the inspection apparatus to: perform an image acquisition processing to acquire an image of the pixels of the display device with sensor pixels; perform a locating processing to locate positions of defect candidates of the display device in the image captured by the image acquisition processing; perform a contour generation processing to generate a contour of the defect candidate of the display device based on the position of the defect candidate of the display device; and perform a determination processing to determine whether the defect candidate is a defect of the display device based on a perimeter of the contour.

According to some embodiments, a method of manufacturing organic light-emitting devices includes the steps of: acquiring an image, with sensor pixels, of a plurality of pixels that are organic light-emitting devices arrayed in a display device; locating a position of a defect candidate of the display device in the image captured in the image acquisition step; generating a contour of the defect candidate of the display device based on the position of the defect candidate of the display device; and determining whether the defect candidate is a defect of the display device based on a perimeter of the contour.

Further features of the present invention will become apparent from the following description of exemplary embodiments with reference to the attached drawings.

### BRIEF DESCRIPTION OF THE DRAWINGS

FIG. 1 is a configuration diagram of an inspection apparatus for defect detection according to Embodiment 1.

FIG. 2 is a configuration diagram of an address generation unit in First Embodiment.

FIG. 3 is a configuration diagram of a contour generation unit in First Embodiment.

FIG. 4 is a configuration diagram of a determination unit in First Embodiment.

FIG. 5 is an example of a flowchart of a process executed by the inspection apparatus in First Embodiment.

FIG. 6A to FIG. 6C are examples of images of a display device acquired by an image acquisition unit in First Embodiment.

FIG. 7 is an example of a binarized image generated by the address generation unit in First Embodiment.

FIG. 8 is an example of contour data generated by the contour generation unit in First Embodiment.

FIG. 9 is an example of contour data of defects in the display device generated by the contour generation unit in First Embodiment.

FIG. 10 is an example of contour data of a sensor defect generated by the contour generation unit in First Embodiment.

FIG. 11 shows examples of contours with a perimeter of 8 generated by the contour generation unit in First Embodiment.

FIG. 12 is an example of defect information generated by a defect information generation unit in First Embodiment.

FIG. 13 is a configuration diagram of an address generation unit in Second Embodiment.

FIG. 14 is an example of data complementation applied by a complement unit to a binarized image in Second Embodiment.

FIG. 15 is a configuration diagram of a determination unit in Third Embodiment.

FIG. 16 is a diagram explaining determination results output from the determination unit in Third Embodiment.

FIG. 17 is a diagram explaining contour buffer modes of the determination unit in Third Embodiment.

FIG. 18 is a diagram illustrating one example of a display device according to an embodiment of the present invention.

FIG. 19A and FIG. 19B are diagrams illustrating examples of an imaging device and an electronic device according to an embodiment.

FIGS. 20A and 20B are diagrams illustrating examples of display devices according to an embodiment.

FIG. 21A and FIG. 21B are diagrams illustrating one example of an automobile with an illumination device and a lamp according to an embodiment.

FIG. 22A and FIG. 22B are diagrams illustrating examples of wearable devices according to an embodiment.

### DESCRIPTION OF THE EMBODIMENTS

Hereinafter, the present invention will be described in more detail based on preferable embodiments with reference to the accompanying drawings. It should be noted that the configurations shown in the embodiments below are merely examples and the present invention shall not be limited to the illustrated configurations.

### First Embodiment

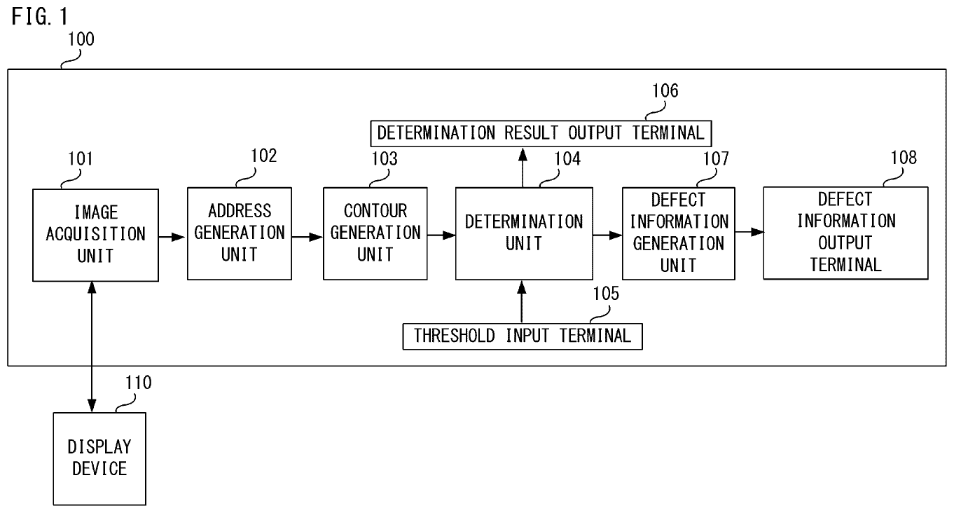

The configuration of an inspection apparatus for defect detection according to a first embodiment of the present invention will be described with reference to the block diagram of FIG. 1. As shown in FIG. 1, the inspection apparatus 100 includes an image acquisition unit 101, an address generation unit 102, a contour generation unit 103, a determination unit 104, a threshold input terminal 105, a determination result output terminal 106, a defect information generation unit 107, and a defect information output terminal 108. The image acquisition unit 101 is a camera or the like that perform an image acquisition processing to acquire images of a display device 110 to be inspected. The display device 110 includes a display unit with an array of pixels. The address generation unit 102 performs a generation processing to generate binarized images that indicate positions (addresses) of defects in the pixels of the display device 110 and defects in the pixels of the sensor in the image acquisition unit 101 on the image captured by the image acquisition unit 101. The contour generation unit 103 performs a generation processing to generate contour data of defects. The determination unit 104 performs defect determination using the contour data generated by the contour generation unit 103 and a defect detection threshold for the contour data input from the threshold input terminal 105. The determination unit 104 outputs determination results data to external equipment from the determination result output terminal 106. The defect information generation unit 107 generates information of the defect determined by the determination unit 104 as a defect in the display device 110, such as the position, size, and pixel value. The defect information generated by the defect information generation unit 107 is output to external equipment from the defect information output terminal 108. Note that each unit of the inspection apparatus 100 is realized by a central processing unit (CPU) or the like, and the CPU comprehensively controls processing in the inspection apparatus 100.

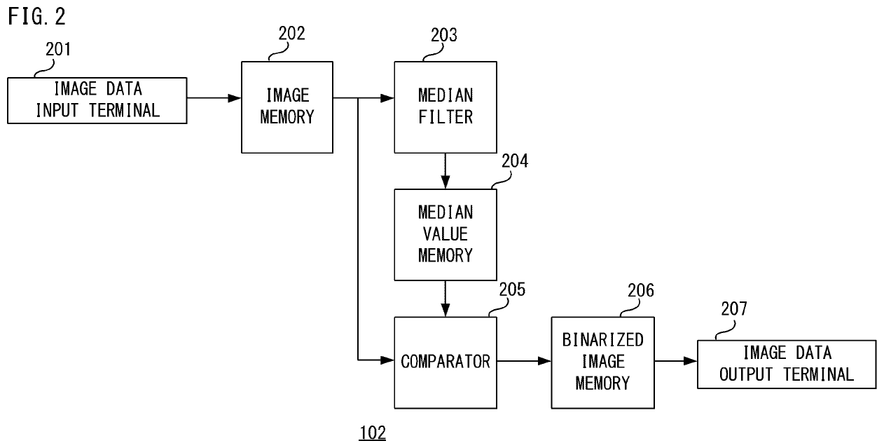

FIG. 2 shows the configuration of the address generation unit 102. The address generation unit 102 includes an image data input terminal 201, an image memory 202, a median filter 203, a median value memory 204, a comparator 205, a binarized image memory 206, and an image data output terminal 207. The address generation unit 102 is a locating unit that performs a locating processing to locate the positions of defect candidates in the display device in the image captured by the image acquisition unit. The image data acquired by the image acquisition unit 101 is stored in the image memory 202 via the image data input terminal 201. The image data for one image is stored in the image memory 202 per inspection. In this embodiment, the image acquisition unit 101 is a monochrome camera, for example, which acquires 8-bit monochrome images. If the image acquisition unit 101 is a color camera, the address generation unit 102 converts the color image into a monochrome image in a monochrome conversion unit (not shown) before storing the image data in the image memory 202.

The median filter 203 calculates a median value for each pixel of the image data. The median value memory 204 stores the median values of respective pixels calculated by the median filter 203. The comparator 205 compares the value of each pixel of the image data stored in the image memory 202 with the corresponding median value read from the median value memory 204. The comparator 205 outputs the comparison results data as a binarized image that indicates the addresses of defects in the display device 110 or sensor defects. The output binarized image is stored in the binarized image memory 206. The binarized image data stored in the binarized image memory 206 is output from the image data output terminal 207 to the contour generation unit 103.

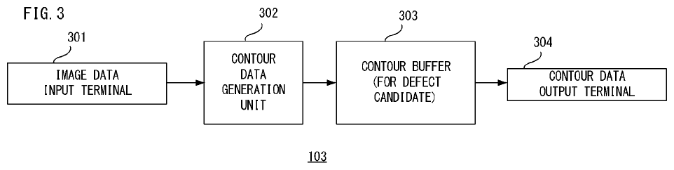

FIG. 3 shows the configuration of the contour generation unit 103. The contour generation unit 103 includes an image data input terminal 301, a contour data generation unit 302, a contour buffer 303, and a contour data output terminal 304. The contour generation unit 103 generates contours of defect candidates of the display device based on the positions of the defect candidates. The binarized image data output from the address generation unit 102 is sent to the contour data generation unit 302 via the image data input terminal 301. The contour data generation unit 302 generates contour data based on the binarized image data. The contour data generated by the contour data generation unit 302 is stored in the contour buffer 303. This contour data includes contours of defect candidates in the display device 110 and of the sensor. The contour data indicating defect candidates and stored in the contour buffer 303 is output to the determination unit 104 via the contour data output terminal 304.

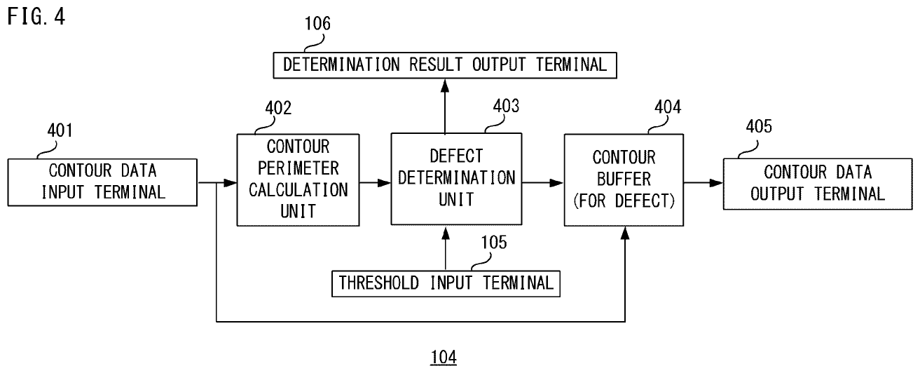

FIG. 4 shows the configuration of the determination unit 104. The determination unit 104 includes a contour data input terminal 401, a contour perimeter calculation unit 402, a defect determination unit 403, a contour buffer 404, and a contour data output terminal 405. The defect determination unit 403 is connected to the threshold input terminal 105 and the determination result output terminal 106. The determination unit 104 determines if a defect candidate is a defect in the display device based on the contour perimeter. The contour data output from the contour generation unit 103 is input to the contour perimeter calculation unit 402 via the contour data input terminal 401. The contour perimeter calculation unit 402 calculates contour perimeters, i.e., the length of each contour, based on the contour data. The defect determination unit 403 compares the contour perimeters calculated by the contour perimeter calculation unit 402 with the defect detection threshold of the display device 110 input from the threshold input terminal 105 to determine if the candidates are defects. The determination results are output from the determination result output terminal 106, which is a notification unit, to notify external equipment. The defect determination unit 403 outputs a signal to the contour buffer 404 indicating that the contour has been determined as that of a defect in the display device 110. The contour buffer 404 stores contours in the contour data input from the contour data input terminal 401 that have been determined as indicating defects. The contour data stored in the contour buffer 404 is output to the defect information generation unit 107 via the contour data output terminal 405.

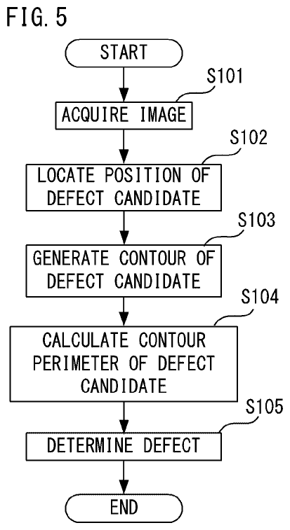

FIG. 5 shows one example of a flowchart of a defect detection process executed by the CPU of the inspection apparatus 100 according to this embodiment. At step S101, the image acquisition unit 101 acquires an image of pixels of the display device 110. Next, at step S102, the address generation unit 102 locates the positions of defect candidate pixels in the display device 110 based on the image captured by the image acquisition unit 101. Next, at step S103, the contour generation unit 103 generates contour data of the defect candidates based on the positions of the defect candidates located by the address generation unit 102. Next, at step S104, the contour perimeter calculation unit 402 calculates the contour perimeters of the defect candidates based on the contour data of the defect candidates generated by the contour generation unit 103. At step S105, the defect determination unit 403 determines whether the defect candidates are defects in the display device 110 based on the contour perimeter calculated by the contour perimeter calculation unit 402.

In one application example where the display device 110 includes multiple pixels of organic light-emitting devices, the manufacturing process of the organic light-emitting devices may include a step in which the inspection apparatus 100 executes the inspection process according to the above-described flowchart for defect detection. This realizes inspection for detecting defects in display devices without using sensor defect data during a manufacturing process of organic light-emitting devices.

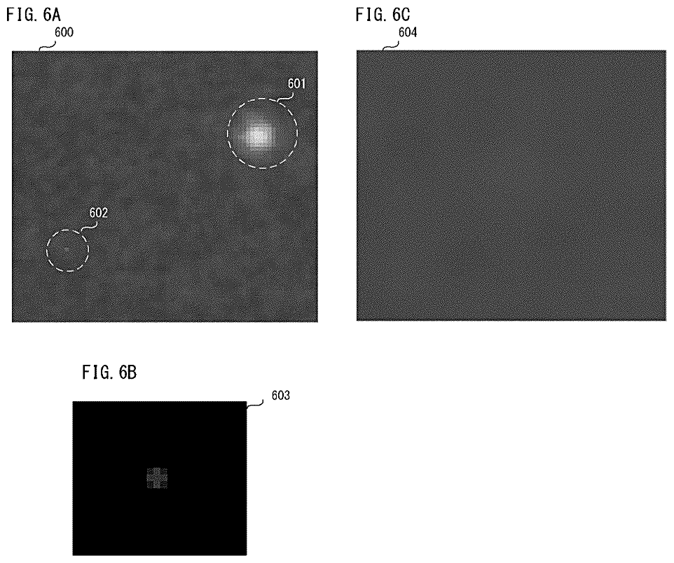

Next, the operation of the inspection apparatus 100 is described in detail with reference to FIG. 6 to FIG. 12.

First, the inspection apparatus 100 captures an image of the display device 110 using the image acquisition unit 101 and acquires image data. The image data is stored in the image memory 202 of the address generation unit 102. FIG. 6A shows one example of image data 600 acquired by the image acquisition unit 101. The image data 600 includes a defect 601 or bright dot in the display device 110 (defective pixel with higher brightness than the surrounding pixels) and a defect 602 of the sensor. FIG. 6B is an enlarged view of a portion of the image data 600 including the defect 602 of the sensor. FIG. 6B shows that the defect in one sensor pixel appears as a cross extending vertically and horizontally over 3 sensor pixels each (i.e., 3×3=9 pixels).

Therefore, in this embodiment, to distinguish a defect in one pixel of the display device 110 from a sensor defect, the image acquisition unit 101 captures an image of one pixel of the display device 110 with at least nine or more sensor pixels. Thus, the size of the sensor pixels of the image acquisition unit 101 is one ninth or less of the size of the pixels of the display device 110.

The median filter 203 reads the image data from the image memory 202, and calculates a median value of, for example, 15×15 (=225) pixels for each pixel. The calculated median values are stored in the median value memory 204. Reference numeral 604 denotes an example of image data replaced with the median values stored in the median value memory 204. The size (of the range) of pixels for the median filter 203 to calculate a median value is set such as to remove the influence of shading and noise in the pixels surrounding the target pixel. As long as similar effects are achieved, a mean filter that calculates average values using the target pixel and surrounding pixels may be used instead of the median filter.

After that, the comparator 205 compares the value of each pixel of the image data stored in the image memory 202 with the corresponding median value read from the median value memory 204. The comparison results are output as a binarized image that indicates the addresses of defects in the display device 110 or of sensor defects. The image data of the output binarized image is stored in the binarized image memory 206. The address generation unit 102 is thus able to generate binarized images that indicate the positions of defect candidates based on the results of comparison between the pixel values of the sensor pixels and a feature calculated from the pixel values of the pixels surrounding the target sensor pixel.

Specific examples of comparison operations executed by the comparator 205 are explained below. In the following, the x and y coordinates represent points in image data placed on an XY plane with X axis and Y axis perpendicular to each other.

For detecting bright dots, the value at BIN (x, y) in the binarized image data is calculated using the following Expression (1), where M (x, y) represents the median data corresponding to P (x, y) of the image data, with x and y respectively representing x and y coordinates of the image, and “gain” representing the pixel gain.

$$\begin{matrix}\begin{matrix}BIN ( x , y ) = 1 & ( if M ( x , y ) * gain - P ( x , y ) \leq 0 )\end{matrix} \\ BIN ( x , y ) = 0 ( else )\end{matrix} \} \qquad ( 1 )$$

If gain=1.4, for example, BIN (x, y) of the binarized image data will be 1 when P (x, y) of the image data is 1.4 times as large as the median value M (x, y) or more, which indicates the presence of a defect in the display device 110 or a sensor defect at (x, y).

Similarly, for detecting dark dots (defect where the brightness is lower than the surrounding pixels), the value at BIN (x, y) in the binarized image data is calculated using the following Expression (2).

$$\begin{matrix}\begin{matrix}BIN ( x , y ) = 1 & ( if M ( x , y ) * gain - P ( x , y ) \geq 0 )\end{matrix} \\ BIN ( x , y ) = 0 ( else )\end{matrix} \} \qquad ( 2 )$$

If gain=0.5, for example, BIN (x, y) of the binarized image data will be 1 when P (x, y) of the image data is 0.5 times as small as the median value M (x, y) or less, which indicates the presence of a defect in the display device 110 or a sensor defect at (x, y). A sensor defect appears as a bright dot, and therefore the calculation result of Expression (2) will be 0 (BIN (x, y)=0).

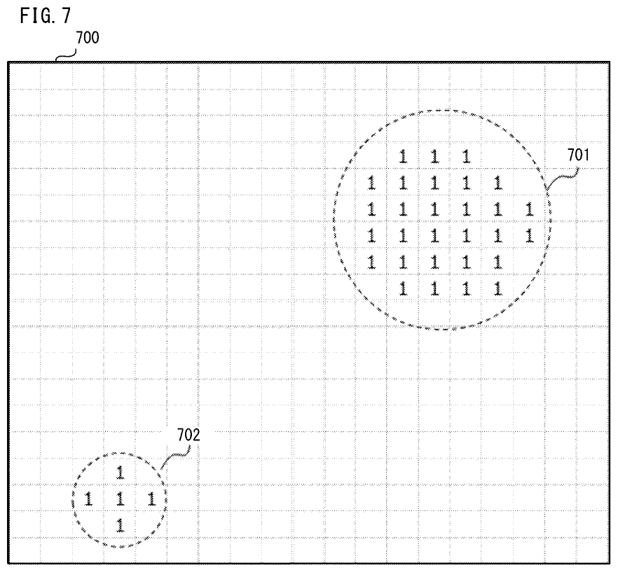

FIG. 7 shows a binarized image 700 of the image data 600 shown in FIG. 6. In the binarized image 700, dotted-line circle 701 encircles the defect 601 in the display device 110 (coordinates labeled “1” in the drawing), and dotted-line circle 702 encircles the defect 602 of the sensor (coordinates labeled “1” in the drawing).

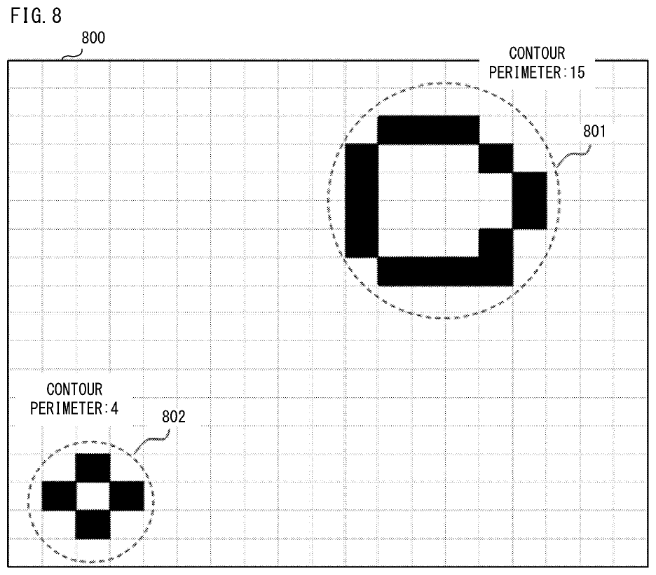

The binarized image data read from the binarized image memory 206 is output to the contour generation unit 103 via the image data output terminal 207. FIG. 8 shows one example of contour data 800 generated by the contour generation unit 103 using the binarized image data of FIG. 7. In the contour data 800, dotted-line circle 801 encircles a contour (black pixels in the drawing) generated from the coordinates of the defect 601 in the display device 110, and dotted-line circle 802 encircles a contour (black pixels in the drawing) generated from the coordinates of the defect 602 of the sensor.

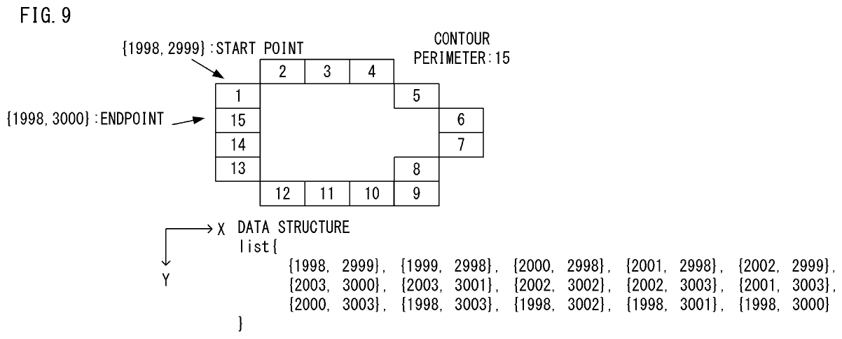

FIG. 9 shows the data structure of the contour encircled by the circle 801 in FIG. 8. As shown in FIG. 9, the coordinates of the start point of the contour encircled by the circle 801 are [1998, 2999]. Here, the point in the contour where the x coordinate is the smallest and the y coordinate is the smallest is determined as the start point. Coordinates of the points along the contour are then successively extracted clockwise from the start point to the endpoint which is at coordinates [1998, 3000] in FIG. 9. These coordinates are stored as one list in the contour buffer 303.

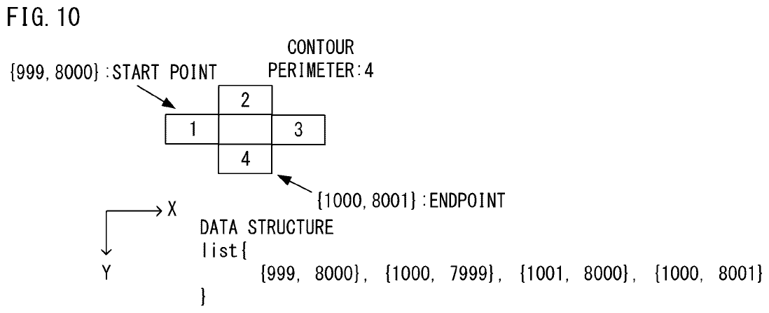

Similarly, FIG. 10 shows the data structure of the contour encircled by the circle 802 in FIG. 8. As shown in FIG. 10, the coordinates of the start point of the contour encircled by the circle 802 are [999, 8000]. Similarly to the case with FIG. 9, the point in the contour where the x coordinate is the smallest and the y coordinate is smallest is determined as the start point. Coordinates of the points along the contour are then successively extracted clockwise from the start point to the endpoint which is at coordinates [1988, 8000] in FIG. 10. These coordinates are stored as one list in the contour buffer 303. The coordinates data of the contours read from the contour buffer 303 is then output to the determination unit 104 from the contour data output terminal 304. The order of extracting coordinates from the start point to the endpoint in creating the list of coordinates of the contours described above is one example. The list may be created by successively extracting coordinates counterclockwise from the start point to the endpoint.

Next, the contour perimeter calculation unit 402 of the determination unit 104 generates contour perimeters using the coordinates data of the contours. In the case of the contour encircled by the circle 801 in FIG. 8, for example, the contour perimeter calculation unit 402 calculates the contour perimeter as 15, which is the number of coordinates in the list in FIG. 9. The contour perimeter of the contour encircled by the circle 802 in FIG. 8 equals to the number of coordinates in the list in FIG. 10, and therefore the contour perimeter calculation unit 402 calculates the contour perimeter as 4. The data of the calculated contour perimeters is output to the defect determination unit 403, which uses it to determine whether the candidates are defects in the display device 110.

In this embodiment, the determination unit 104 distinguishes a defect in the display device 110 from a defect in a sensor pixel of the image acquisition unit 101 based on the size of the defects contained in the image captured by the image acquisition unit 101. Specifically, in one example, a contour perimeter threshold of 8 is set from the threshold input terminal 105 to allow a defect spanning 8 sensor pixels or more as a defect in the display device. Thus, the contour perimeter 8 is set as the defect determination threshold for the determination unit 104 to be able to detect defects of a visible size. Since the contour perimeter 15 of the defect 601 is more than the defect determination threshold, this is determined as a defect in the display device 110 in this case. The defect 601 spans 28 sensor pixels, and therefore the defect determination is correct. The contour perimeter 4 of the defect 602 is less than the defect determination threshold, and therefore this is determined as a sensor defect. The defect 602 spans 5 sensor pixels, and therefore the defect determination is correct.

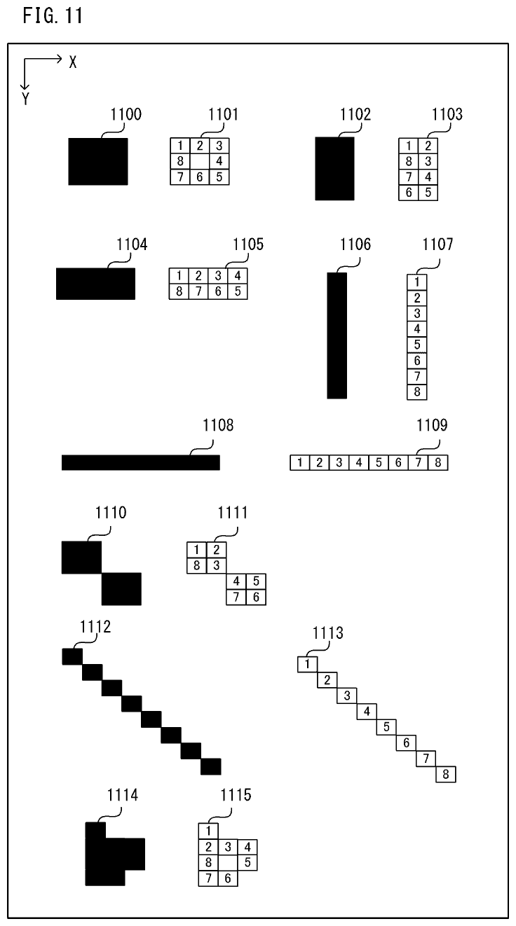

Some more specific examples of contour perimeters that will be determined as defects in the display device 110 by the defect determination unit 403 will be described with reference to FIG. 11. The contour perimeter threshold is set to 8 from the threshold input terminal 105, so that defects spanning 8 sensor pixels or more will be determined as defects in the display device 110. The X axis and Y axis perpendicular to each other are set as shown in FIG. 11.

In FIG. 11, reference numeral 1100 denotes a defect that spans 3×3=9 sensor pixels. The contour data is generated in the order 1101 of pixels and the contour perimeter is calculated as 8. Therefore, the defect determination unit 403 determines the defect 1100 as a defect in the display device 110. Reference numeral 1102 denotes a vertically long defect that spans 2×4=8 sensor pixels. The contour data is generated in the order 1103 of pixels and the contour perimeter is calculated as 8. Therefore, the defect determination unit 403 determines the defect 1102 as a defect in the display device 110. Similarly, reference numeral 1104 denotes a horizontally long defect that spans 4×2=8 sensor pixels. The contour data is generated in the order 1105 of pixels and the contour perimeter is calculated as 8. Therefore, the defect determination unit 403 determines the defect 1104 as a defect in the display device 110.

Reference numeral 1106 denotes a vertically long defect that spans 1×8=8 sensor pixels. The contour data is generated in the order 1107 of pixels and the contour perimeter is calculated as 8. The contour generation unit 302 generates contour data by successively extracting coordinates from the start point 1 to point 8 clockwise (positive direction of the Y axis) in accordance with the order 1107 of pixels for generating contour data. The contour generation unit 302 then generates contour data from the coordinates of point 8 to point 1 in the negative direction of the Y axis. In creating the contour data, the contour generation unit 302 does not add the coordinates that have already been added to the list in duplicate. Therefore, the contour generation unit 302 generates a list of eight coordinates as the contour data. The contour perimeter calculation unit 402 thus calculates the contour perimeter of the defect 1106 as 8, so that the defect determination unit 403 determines the defect 1106 as a defect in the display device 110.

Similarly, reference numeral 1108 denotes a horizontally long defect that spans 8×1=8 sensor pixels. The contour data is generated in the order 1109 of pixels and the contour perimeter is calculated as 8. The contour generation unit 302 generates contour data by successively extracting coordinates from the start point 1 to point 8 clockwise (positive direction of the X axis) in accordance with the order 1109 of pixels for generating contour data. The contour generation unit 302 then generates contour data from the coordinates of point 8 to point 1 in the negative direction of the X axis. Similarly to the case of the defect 1106, the contour generation unit 302 does not add the coordinates that have already been added to the list in duplicate when creating contour data. Therefore, the contour generation unit 302 generates a list of eight coordinates as the contour data. The contour perimeter calculation unit 402 thus calculates the contour perimeter of the defect 1108 as 8, so that the defect determination unit 403 determines the defect 1108 as a defect in the display device 110.

Reference numeral 1110 denotes a defect that includes two diagonally neighboring defects each spanning 2×2=4 sensor pixels. The contour data is generated in the order 1111 of pixels and the contour perimeter is calculated as 8. The contour generation unit 302 generates contour data by successively extracting coordinates from the start point 1 to point 8 clockwise in accordance with the order 1111 of pixels for generating contour data. While points 4 and 3 follow point 7 according to the order 1111 of pixels for generating contour data, the contour generation unit 302 does not add the coordinates that have already been added to the list in duplicate when creating contour data. Therefore, the contour generation unit 302 generates a list of eight coordinates as the contour data. The contour perimeter calculation unit 402 thus calculates the contour perimeter of the defect 1110 as 8, so that the defect determination unit 403 determines the defect 1110 as a defect in the display device 110.

Reference numeral 1112 denotes a defect that spans eight diagonally neighboring sensor pixels. The contour data is generated in the order 1113 of pixels and the contour perimeter is calculated as 8. The contour generation unit 302 generates contour data by successively extracting coordinates from the start point 1 to point 8 clockwise (positive direction of the X axis and the Y axis) in accordance with the order 1113 of pixels for generating contour data. The contour generation unit 302 then generates contour data from the coordinates of point 8 to point 1 in the negative direction of the X axis and the Y axis. In creating the contour data, the contour generation unit 302 does not add the coordinates that have already been added to the list in duplicate. Therefore, the contour generation unit 302 generates a list of eight coordinates as the contour data. The contour perimeter calculation unit 402 thus calculates the contour perimeter of the defect 1112 as 8, so that the defect determination unit 403 determines the defect 1112 as a defect in the display device 110.

Reference numeral 1114 denotes a defect that spans 9 sensor pixels. The contour data is generated in the order 1115 of pixels and the contour perimeter is calculated as 8. The contour generation unit 302 generates contour data by successively extracting coordinates from the start point 1 clockwise in accordance with the order 1115 of pixels for generating contour data. While point 2 follows point 8 in the order of pixels, the contour generation unit 302 does not add the coordinates that have already been added to the list in duplicate. Therefore, the contour generation unit 302 generates a list of eight coordinates as the contour data. The contour perimeter calculation unit 402 thus calculates the contour perimeter of the defect 1114 as 8, so that the defect determination unit 403 determines the defect 1114 as a defect in the display device 110.

FIG. 11 shows some examples of defects and the contour perimeters of defects in the display device 110. Contour data is generated and the contour perimeters are calculated similarly to the manner described above for defects of other shapes. Thus, the defect determination unit 403 can determine whether or not a defect candidate is a defect in the display device 110. The contour perimeter threshold set from the threshold input terminal 105 may be a value corresponding to the size of one pixel of the display device that is the inspection target. Alternatively, the contour perimeter threshold set from the threshold input terminal 105 may be a value corresponding to the size of a defect that raises no visual issues when perceived by human eyes.

The results of determination by the defect determination unit 403 are output from the determination result output terminal 106 to be notified to external equipment. For example, if the image data stored in the image memory 202 contains even one defect in the display device 110, value 1 is output from the determination result output terminal 106. If the image data stored in the image memory 202 contains no defects in the display device 110, value 0 is output from the determination result output terminal 106. Contours representing the defects in the display device 110 are stored in the contour buffer 404 in accordance with the signal output from the defect determination unit 403.

The contour data read from the contour buffer 404 is then output to the defect information generation unit 107 from the contour data output terminal 405. The defect information generation unit 107 generates defect information of the display device 110 using the contour data output from the contour data output terminal 405.

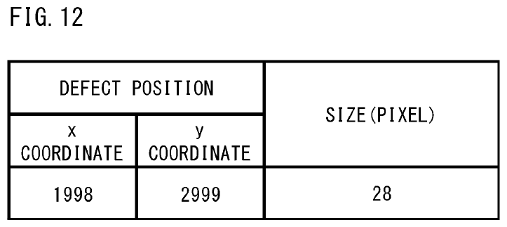

FIG. 12 shows one example of defect information generated from the contour data shown in FIG. 9 by the defect information generation unit 107. The defect information generation unit 107 locates the coordinates in the defect from the contour data shown in FIG. 9, and calculates the size of the defect (number of sensor pixels) from the number of located coordinates. The coordinates of the “defect position” in the defect information shown in FIG. 12 are the coordinates at the top of the list of the contour data (start point coordinates). The coordinates of the “defect position” may instead be the coordinates of the center of gravity of the defect calculated from the contour data. The defect information generated by the defect information generation unit 107 is output from the defect information output terminal 108.

In this embodiment, defects in the display device 110 were described as bright dots. Defect determination can be performed similarly to the manner described above using the contour perimeter when a defect in the display device 110 is a dark dot.

As demonstrated above, the inspection apparatus 100 for defect detection according to this embodiment allows for accurate determination of defects in the display device 110 based on the contour perimeters of defects contained in the image data of the display device 110, without defect data conventionally used in existing techniques.

### Second Embodiment

Next, the configuration of an inspection apparatus for defect detection according to a second embodiment of the present invention will be described. The overall configuration of the inspection apparatus 100 according to this embodiment is the same as that of the first embodiment except for the address generation unit 102. The configurations similar to those of the first embodiment are given the same reference numerals and will not be described in detail in the following description.

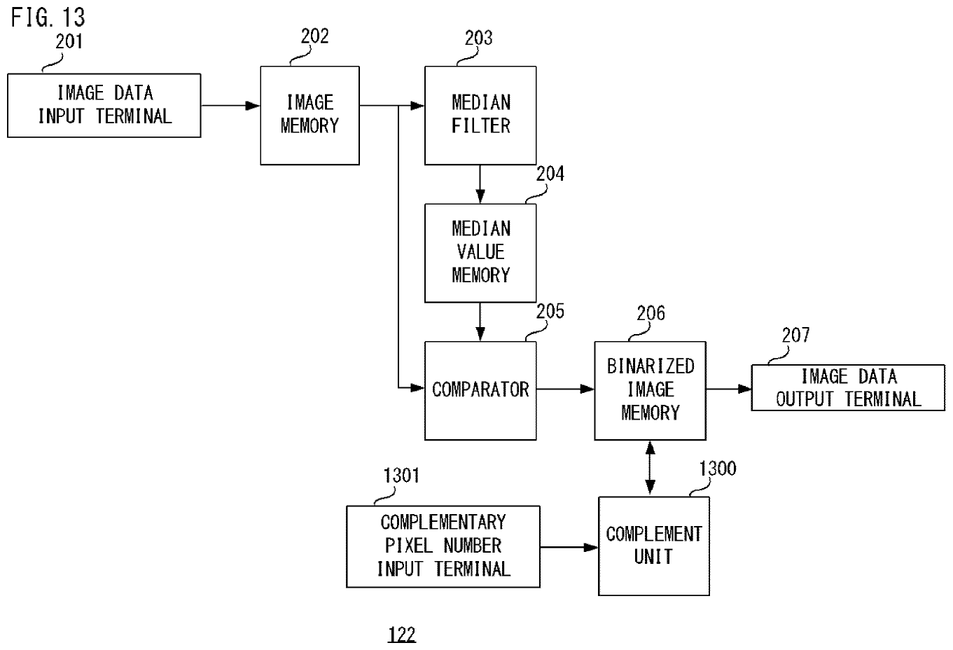

FIG. 13 shows the configuration of the address generation unit 122 in the inspection apparatus 100 of this embodiment. The address generation unit 122 includes an image data input terminal 201, an image memory 202, a median filter 203, a median value memory 204, a comparator 205, a binarized image memory 206, an image data output terminal 207, a complement unit 1300, and a complementary pixel number input terminal 1301.

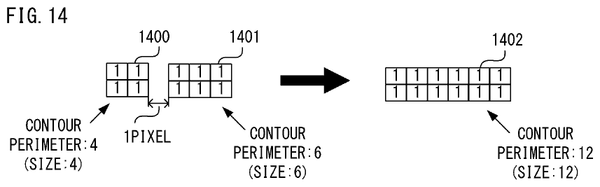

As has been described with reference to FIG. 2, binarized images that indicate addresses of defects in the display device 110 are stored in the binarized image memory 206. FIG. 14 shows an example of a process of calculating a contour perimeter in a binarized image in this embodiment. The binarized image 1400 shown in FIG. 14 corresponds to a defect in the display device 110 with a contour perimeter of 4 (spanning 4 sensor pixels). The binarized image 1401 corresponds to a defect in the display device 110 with a contour perimeter of 6 (spanning 6 sensor pixels). The defects represented as the binarized images 1400 and 1401 are separated from each other by one sensor pixel. When perceived by human eyes, the two defects corresponding to the binarized images 1400 and 1401 appear as connected. Therefore, preferably, the binarized images 1400 and 1401 should together be determined as a defect in the display device 110. When the contour perimeter threshold is set to 8 from the threshold input terminal 105, the defect determination unit 403 will not determine these binarized images 1400 and 1401 as defects in the display device 110, as these binarized images each have a contour perimeter of less than 8.

In this embodiment, the address generation unit 122 is provided with an complement unit 1300. First, the complement unit 1300 reads out the binarized images 1400 and 1401 shown in FIG. 14 from the binarized image memory 206. The complement unit 1300 then applies complementation to the value of the pixel between the defect addresses of the binarized images 1400 and 1401. The number of pixels to be imputed by the complement unit 1300 is set via the imputed pixel number input terminal 1301. Here, as one example, the number of pixels to be imputed by the complement unit 1300 is set to 1, so that complementation is applied to one sensor pixel.

FIG. 14 also shows a binarized image 1402 acquired after the complementation performed on the binarized images 1400 and 1401 by the complement unit 1300. Since the binarized images 1400 and 1401 are separated from each other by only one sensor pixel, the complement unit 1300 replaces the value of the one sensor pixel between the binarized images 1400 and 1401 to a defect address.

The complement unit 1300 outputs the binarized image 1402 after the complementation to the binarized image memory 206, so that the binarized image 1402 is stored in the binarized image memory 206. The image data of the binarized image 1402 stored in the binarized image memory 206 is output to the contour generation unit 103 from the image data output terminal 207.

The binarized image 1402 contains the binarized images 1400 and 1401 connected to each other by the defect address in place of the pixel between them, and has a contour perimeter of 12. The defect determination unit 403 thus determines the image as representing a defect in the display device 110, since the binarized image 1402 after the complementation has a larger contour perimeter than the contour perimeter threshold 8.

As described above, complementation of binarized images by the complement unit 1300 in the address generation unit 122 is expected to improve the accuracy of detecting defects in the display device 110 according to the inspection apparatus 100 of this embodiment.

### Third Embodiment

Next, the configuration of an inspection apparatus for defect detection according to a third embodiment of the present invention will be described. The overall configuration of the inspection apparatus 100 according to this embodiment is the same as that of the first embodiment except for the determination unit 104. The configurations similar to those of the first embodiment are given the same reference numerals and will not be described in detail in the following description.

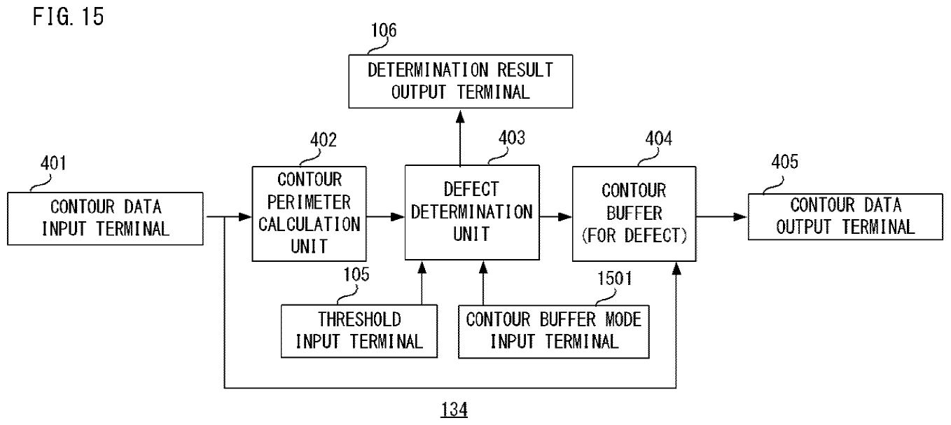

FIG. 15 shows the configuration of the determination unit 134 in the inspection apparatus 100 of this embodiment. The determination unit 134 includes a contour data input terminal 401, a contour perimeter calculation unit 402, a defect determination unit 403, a contour buffer 404, a contour data output terminal 405, and a contour buffer mode input terminal 1501.

As has been described with reference to FIG. 4, the contour perimeter calculation unit 402 calculates contour perimeters. The defect determination unit 403 compares the contour perimeters calculated by the contour perimeter calculation unit 402 with the defect detection threshold of the display device 110 input from the threshold input terminal 105 to determine if a candidate is a defect. The determination results are output to external equipment from the determination result output terminal 106. The defect determination unit 403 outputs a signal to the contour buffer 404 indicating that the contour has been determined as that of a defect in the display device 110. The defect determination unit 403 manages storage of the contour data in the contour buffer 404 based on the value set from the contour buffer mode input terminal 1501. This control process will be described in more detail later. The contour buffer 404 stores contours in the contour data input from the contour data input terminal 401 when they have been determined as those of defects. The contour data stored in the contour buffer 404 is output to the defect information generation unit 107 via the contour data output terminal 405.

Next, the operation of the determination unit 134 will be explained. Here, as with the case described in the first embodiment, defect determination shall be performed on the image data shown in FIG. 6A. A contour perimeter threshold of 8 is set from the threshold input terminal 105, so that defects spanning 8 sensor pixels or more will be determined as defects in the display device 110 by the determination unit 134. Since the contour perimeter 15 is larger than the threshold 8, the defect 601 is determined as a defect in the display device 110. The contour perimeter 4 of the defect 602 is smaller than the threshold 8, and therefore the defect 602 is determined as a defect of the sensor.

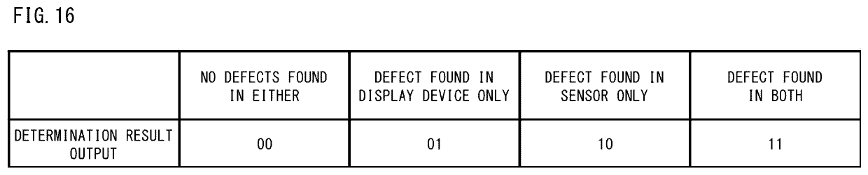

Next, the determination results output from the determination result output terminal 106 will be explained with reference to FIG. 16. If, for example, the image data stored in the image memory 202 contains neither a defect in the display device 110 nor a sensor defect (“No defects found in either” in the drawing), value 00 is output from the determination result output terminal 106. If the image data stored in the image memory 202 contains a defect in the display device 110 but no sensor defect (“Defect found in display device only” in the drawing), value 01 is output from the determination result output terminal 106. If the image data stored in the image memory 202 contains no defect in the display device 110 but a sensor defect (“Defect found in sensor only” in the drawing), value 10 is output from the determination result output terminal 106. If the image data stored in the image memory 202 contains both a defect in the display device 110 and a sensor defect (“Defect found in both” in the drawing), value 11 is output from the determination result output terminal 106.

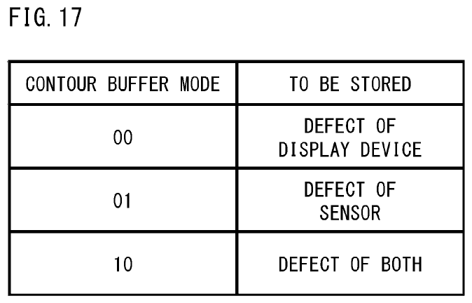

Next, how the defect determination unit 403 controls the contour buffer 404 based on the setting from the contour buffer mode input terminal 1501 will be explained with reference to FIG. 17. If value 00 is set from the contour buffer mode input terminal 1501, contour data representing a defect in the display device 110 is stored in the contour buffer 404. In this case, therefore, the defect determination unit 403 controls the contour buffer 404 to store contour data representing a defect in the display device 110, in accordance with the value input from the contour buffer mode input terminal 1501. If value 01 is set from the contour buffer mode input terminal 1501, contour data representing a sensor defect is stored in the contour buffer 404. In this case, therefore, the defect determination unit 403 controls the contour buffer 404 to store contour data representing a sensor defect, in accordance with the value input from the contour buffer mode input terminal 1501. If value 11 is set from the contour buffer mode input terminal 1501, contour data representing a defect in the display device 110 as well as contour data representing a sensor defect is stored in the contour buffer 404. In this case, therefore, the defect determination unit 403 controls the contour buffer 404 to store contour data representing a defect in the display device 110 as well as contour data representing a sensor defect, in accordance with the value input from the contour buffer mode input terminal 1501. The contour data read from the contour buffer 404 is then output to the defect information generation unit 107 from the contour data output terminal 405.

In the third embodiment, the determination unit 134 outputs defect information of the sensor as well as the defect information of the display device 110. Therefore, the inspection apparatus 100 not only detects defects in the display device 110 but also allows for analysis of chronological change in sensor defects in the image acquisition unit 101.

Similarly to the first embodiment, the inspection apparatus 100 according to this embodiment allows for accurate determination of defects in the display device 110 based on the contour perimeters of defects contained in the image data of the display device 110, without defect data conventionally used in existing techniques.

The embodiments described above briefly depict the principle of the present invention and actual applications thereof, for those skilled in the art to understand the invention. Other embodiments in which various alterations are made to the inspection apparatus 100 for defect detection may be found suitable for specific purposes. These should also be included in the scope of the present invention.
[Structure of an Organic Light-Emitting Element] An organic light-emitting element employed in an inspection apparatus 100 of any one of the above embodiments will be explained next. As an example, the organic light-emitting element is manufactured by performing the inspection method using the inspection apparatus 100. In the present embodiment the organic light-emitting element is provided by forming an insulating layer, a first electrode, an organic compound layer and a second electrode, on a substrate. A protective layer, a color filter, a microlens and so forth may be provided on a cathode. In a case where a color filter is provided, a planarization layer may be provided between the color filter and the protective layer. The planarization layer can be for instance made up of an acrylic resin. The same is true in a case where the planarization layer is provided between the color filter and the microlens.
[Substrate] At least one material selected from quartz, glass, silicon, resins and metals can be used as the material for the substrate that makes up the organic light-emitting element. Switching elements such as transistors and wiring may be provided on the substrate, and an insulating layer may be provided on the foregoing. Any material can be used as the insulating layer so long as a contact hole can be formed between the insulating layer and the first electrode, and insulation from unconnected wiring can be ensured, so that wiring can be formed between the first electrode and the insulating layer. For instance a resin such as a polyimide, or silicon oxide or silicon nitride can be used herein.
[Electrodes] A pair of electrodes can be used as the electrodes of the organic light-emitting element. The pair of electrodes may be an anode and a cathode. In a case where an electric field is applied in the direction in which the organic light-emitting element emits light, the electrode of higher potential is the anode, and the other electrode is the cathode. Stated otherwise, the electrode that supplies holes to the light-emitting layer is the anode, and the electrode that supplies electrons is the cathode.

A material having a work function as large as possible is preferable herein as a constituent material of the anode. For instance single metals such as gold, platinum, silver, copper, nickel, palladium, cobalt, selenium, vanadium or tungsten, and mixtures containing the foregoing metals, can be used in the anode. Alternatively, alloys obtained by combining these single metals, or metal oxides such as tin oxide, zinc oxide, indium oxide, indium tin oxide (ITO) or indium zinc oxide, may be used in the anode. Conductive polymers such as polyaniline, polypyrrole and polythiophene can also be used in the anode.

Any of the foregoing electrode materials may be used singly; alternatively, two or more materials may be used concomitantly. The anode may be made up of a single layer, or may be made up of a plurality of layers. In a case where an electrode of the organic light-emitting element is configured in the form of a reflective electrode, the electrode material can be for instance chromium, aluminum, silver, titanium, tungsten, molybdenum, or alloys or layered bodies of the foregoing. The above materials can also function as a reflective film not having a role as an electrode. In a case where an electrode of the organic light-emitting element is configured in the form of a transparent electrode, for instance an oxide transparent conductive layer of for instance indium tin oxide (ITO) or indium zinc oxide can be used, although not particularly limited thereto, as the electrode material. The electrodes may be formed by photolithography.

A material having a small work function may be a constituent material of the cathode. For instance alkali metals such as lithium, alkaline earth metals such as calcium, single metals such as aluminum, titanium, manganese, silver, lead or chromium, and mixtures of the foregoing, may be used herein. Alternatively, alloys obtained by combining these single metals can also be used. For instance magnesium-silver, aluminum-lithium, aluminum-magnesium, silver-copper or zinc-silver can be used. Metal oxides such as indium tin oxide (ITO) can also be used. These electrode materials may be used singly as one type, or two or more types can be used concomitantly. Also, the cathode may have a single-layer structure or a multilayer structure. Silver is preferably used among the foregoing, and more preferably a silver alloy, in order to reduce silver aggregation. Any alloy ratio can be adopted, so long as silver aggregation can be reduced. A ratio silver:other metal may be for instance 1:1, or 3:1.

Although not particularly limited thereto, the cathode may be a top emission element that utilizes an oxide conductive layer of ITO or the like, or may be a bottom emission element that utilizes a reflective electrode of aluminum (Al) or the like. The method for forming the cathode is not particularly limited, but more preferably for instance a DC or AC sputtering method is resorted to, since in that case film coverage is good and resistance can be readily lowered.
[Pixel Separation Layer] The pixel separation layer of the organic light-emitting element is formed out of a silicon nitride (SiN) film, a silicon oxynitride (SiON) film, or a silicon oxide (SiO) film, in turn having been formed by chemical vapor deposition (CVD). In order to increase the in-plane resistance of the organic compound layer, preferably the thickness of the organic compound layer that is formed, particularly a hole transport layer, is set to be small at the side walls of the pixel separation layer. Specifically, the side walls can be formed to be thin by increasing vignetting at the time of deposition, through an increase of the taper angle of the side walls of the pixel separation layer and/or an increase of the thickness of the pixel separation layer.

On the other hand, it is preferable to adjust the side wall taper angle of the pixel separation layer and the thickness of the pixel separation layer so that no voids are formed in the protective layer that is formed on the pixel separation layer. The occurrence of defects in the protective layer can be reduced by virtue of the fact that no voids are formed in the protective layer. Since the occurrence of defects in the protective layer is thus reduced, it becomes possible to reduce loss of reliability for instance in terms of the occurrence of dark spots or defective conduction in the second electrode.

The present embodiment allows effectively suppressing leakage of charge to adjacent pixels even when the taper angle of the side walls of the pixel separation layer is not sharp. Studies by the inventors of the present application have revealed that leakage of charge to adjacent pixels can be sufficiently reduced if the taper angle lies in the range at least 60 degrees and not more than 90 degrees. The thickness of the pixel separation layer is preferably at least 10 nm and not more than 150 nm. A similar effect can be achieved also in a configuration having only a pixel electrode lacking a pixel separation layer. In this case, however, it is preferable to set the film thickness of the pixel electrode to be half or less the thickness the organic layer, or to impart forward taper at the ends of the pixel electrode, at a taper angle smaller than 60 degrees, since short circuits of the organic light-emitting element can be reduced thereby.
[Organic Compound Layer] The organic compound layer of the organic light-emitting element may be formed out of a single layer or multiple layers. In a case where the organic compound layer has multiple layers, these may be referred to as a hole injection layer, a hole transport layer, an electron blocking layer, a light-emitting layer, a hole blocking layer, an electron transport layer or an electron injection layer, depending on the function of the layer. The organic compound layer is mainly made up of organic compounds, but may contain inorganic atoms and inorganic compounds. For instance the organic compound layer may have copper, lithium, magnesium, aluminum, iridium, platinum, molybdenum or zinc. The organic compound layer may be disposed between the first electrode and the second electrode, and may be disposed in contact with the first electrode and the second electrode.

In a case where an organic compound layer includes a plurality of light-emitting layers, a charge generating portion can be disposed between the first light-emitting layer and the second light-emitting layer. The charge generating portion may include an organic compound having a Lowest Unoccupied Molecular Orbital (LUMO) equal to or lower than-5.0 eV. The same can be applied to a case where a charge generating portion is disposed between the second light-emitting layer and the third light-emitting layer, and so forth.
[Protective Layer] In the organic light-emitting element of the present embodiment, a protective layer may be provided on the second electrode. For instance, intrusion of water or the like into the organic compound layer can be reduced, and the occurrence of display defects also reduced, by bonding a glass provided with a moisture absorbent onto the second electrode. As another embodiment, a passivation film of for instance silicon nitride may be provided on the cathode, to reduce intrusion of water or the like into the organic compound layer. For instance, formation of the cathode may be followed by conveyance to another chamber, without breaking vacuum, whereupon a protective layer may be formed through formation of a silicon nitride film having a thickness of 2 μm by CVD. The protective layer may be provided by atomic deposition (ALD), after film formation by CVD. The material of the film formed by ALD is not limited, but may be for instance silicon nitride, silicon oxide or aluminum oxide. Silicon nitride may be further formed, by CVD, on the film having been formed by ALD. The film formed by ALD may be thinner than the film formed by CVD. Specifically, the thickness of the film formed by ALD may be 50% or less, or 10% or less.
[Color Filter] A color filter may be provided on the protective layer of the organic light-emitting element of the present embodiment. For instance a color filter having factored therein the size of the organic light-emitting element may be provided on another substrate, followed by affixing to a substrate having the organic light-emitting element provided thereon; alternatively, a color filter may be patterned by photolithography on the protective layer illustrated above. The color filter may be made up of a polymer.
[Planarization Layer] The organic light-emitting element of the present embodiment may have a planarization layer between the color filter and the protective layer. The planarization layer is provided for the purpose of reducing underlying layer unevenness. The planarization layer may be referred to as a resin layer in a case where the purpose of the planarization layer is not limited. The planarization layer may be made up of an organic compound, which may be a low-molecular or high-molecular compound, preferably a high-molecular compound. The planarization layer may be provided above and below the color filter, and the constituent materials of the respective planarization layers may be identical or dissimilar. Concrete examples include polyvinylcarbazole resins, polycarbonate resins, polyester resins, ABS resins, acrylic resins, polyimide resins, phenolic resins, epoxy resins, silicone resins and urea resins.
[Microlens] The organic light-emitting element may have an optical member such as a microlens, on the light exit side. The microlens may be made up of for instance an acrylic resin or an epoxy resin. The purpose of the microlens may be to increase the amount of light extracted from the organic light-emitting element, and to control the direction of the extracted light. The microlens may have a hemispherical shape. In a case where the microlens has a hemispherical shape, then from among tangent lines that are in contact with the hemisphere there is a tangent line that is parallel to the insulating layer, such that the point of contact between that tangent line and the hemisphere is the apex of the microlens. The apex of the microlens can be established similarly in any cross section. That is, among tangent lines that are in contact with a semicircle of the microlens in a sectional view, there is a tangent line that is parallel to the insulating layer, such that the point of contact between that tangent line and the semicircle is the apex of the microlens.

A midpoint of the microlens can also be defined. Given a hypothetical line segment from the end point of an arc shape to the end point of another arc shape, in a cross section of the microlens, the midpoint of that line segment can be referred to as the midpoint of the microlens. The cross section for discriminating the apex and the midpoint may be a cross section that is perpendicular to the insulating layer.

The microlens has a first surface with a bulge and a second surface on the reverse side from that of the first surface. Preferably, the second surface is disposed closer to a functional layer than the first surface. In adopting such a configuration, the microlens must be formed the organic light-emitting element. In a case where the functional layer is an organic layer, it is preferable to avoid high-temperature processes in the manufacturing process. If a configuration is adopted in which the second surface is disposed closer to the functional layer than the first surface, the glass transition temperatures of all the organic compounds that make up the organic layer are preferably 100° C. or higher, and more preferably 130° C. or higher.
[Counter Substrate] The organic light-emitting element of the present embodiment may have a counter substrate on the planarization layer. The counter substrate is so called because it is provided at a position corresponding to the above-described substrate. The constituent material of the counter substrate may be the same as that of the substrate described above. The counter substrate can be used as the second substrate in a case where the substrate described above is used as the first substrate.
[Organic Layer] Each organic compound layer (hole injection layer, hole transport layer, electron blocking layer, light-emitting layer, hole blocking layer, electron transport layer, electron injection layer and so forth) that makes up the organic light-emitting element of the present embodiment is formed in accordance with one of the methods illustrated below.

A dry process such as vacuum deposition, ionization deposition, sputtering, plasma or the like can be used for the organic compound layers that make up the organic light-emitting element of the present embodiment. A wet process in which a layer is formed through dissolution in an appropriate solvent, relying on a known coating method (for instance spin coating, dipping, casting, LB film deposition to inkjet.) can resorted to instead of a dry process.

When a layer is formed for instance by vacuum deposition or by solution coating, crystallization or the like is unlikelier occur; this translates into superior stability over time. In a case where a film is formed in accordance with a coating method, the film can be formed by being combined with an appropriate binder resin.

Examples of binder resins include, although not limited to, polyvinylcarbazole resins, polycarbonate resins, polyester resins, ABS resins, acrylic resins, polyimide resins, phenolic resins, epoxy resins, silicone resins and urea resins.

These binder resins may be used singly as one type, in the form of homopolymers or copolymers; alternatively, two or more types of binder resin may be used in the form of mixtures. Additives such as known plasticizers, antioxidants and ultraviolet absorbers may be further used concomitantly, as needed.
[Pixel Circuit] A light-emitting device having the organic light-emitting element of the present embodiment may have pixel circuits connected to respective organic light-emitting elements. The pixel circuits may be of active matrix type, and may control independently emission of light by the first organic light-emitting element and the second organic light-emitting element. Active matrix circuits may be voltage-programmed or current-programmed. A drive circuit has a pixel circuit for each pixel. Each pixel circuit may have an organic light-emitting element, a transistor that controls the emission luminance of the organic light-emitting element, a transistor that controls emission timing, a capacitor which holds the gate voltage of the transistor that controls emission luminance, and a transistor for connection to GND bypassing the light-emitting element.

The light-emitting device has a display area and a peripheral area disposed around the display area. The display area has pixel circuits, and the peripheral area has a display control circuit. The mobility of the transistors that make up the pixel circuits may be lower than the mobility of the transistors that make up the display control circuit.

The slope of the current-voltage characteristic of the transistors that make up the pixel circuits may be gentler than the slope of the current-voltage characteristic of the transistors that make up the display control circuit.

The slope of the current-voltage characteristics can be measured on the basis of a so-called Vg-Ig characteristic.

The transistors that make up the pixel circuits are connected to light-emitting elements such as the first organic light-emitting element.
[Pixels] The organic light-emitting element of the present embodiment has a plurality of pixels. The pixels have sub-pixels that emit mutually different colors. The sub-pixels may have for instance respective RGB emission colors.

The pixels emit light in a pixel opening region. This region is the same as the first region. The aperture diameter of the pixel openings may be 15 μm or smaller, and may be 5 μm or larger. More specifically, the aperture diameter of the pixel openings may be for instance 11 μm, or 9.5 μm, or 7.4 μm, or 6.4 μm. The spacing between sub-pixels may be 10 μm or smaller, specifically 8 μm, or 7.4 μm, or 6.4 μm.

The pixels can have any known arrangement in a plan view. For instance, the pixel layout may be a stripe arrangement, a delta arrangement, a penile arrangement or a Bayer arrangement. The shape of the sub-pixels in a plan view may be any known shape. For instance, the sub-pixel shape may be for instance quadrangular, such as rectangular or rhomboidal, or may be hexagonal. Needless to say, the shape of the sub-pixels is not an exact shape, and a shape close to that a of rectangle falls under a rectangular shape. Sub-pixel shapes and pixel arrays can be combined with each other.
[Use of the Organic Light-Emitting Element] The organic light-emitting element according to the present embodiment can be used as a constituent member of a display device or of a lighting device. Other uses of the organic light-emitting element include exposure light sources for electrophotographic image forming apparatuses, backlights for liquid crystal display devices, and light-emitting devices having color filters, in white light sources.

The display device may be an image information processing device having an image input unit for input of image information, for instance from an area CCD, a linear CCD or a memory card, and an information processing unit for processing inputted information, such that an inputted image is displayed on a display unit.

A display unit of an imaging device or of an inkjet printer may have a touch panel function. The driving scheme of this touch panel function may be an infrared scheme, a capacitive scheme, a resistive film scheme or an electromagnetic induction scheme, and is not particularly limited. The display device may also be used in a display unit of a multi-function printer.

Next, an display device according to an embodiment of the present invention is described with reference to the drawings below.

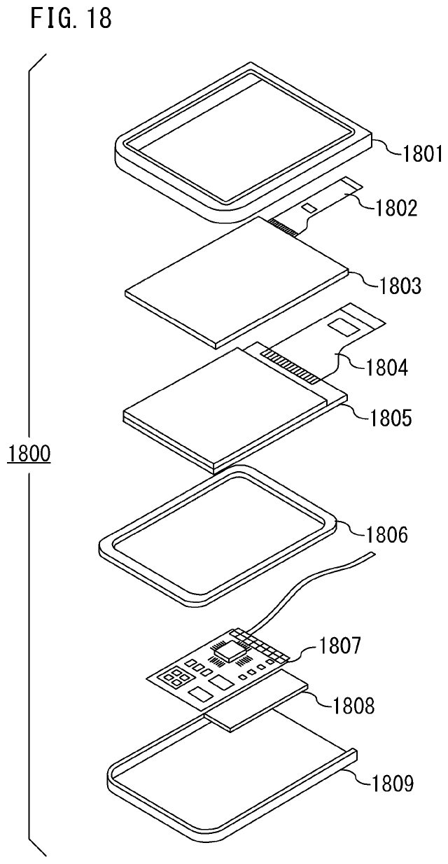

FIG. 18 illustrates a schematic diagram depicting an example of a display device having an organic light-emitting element according to the present embodiment. A display device 1800 may have a touch panel 1803, a display panel 1805, a frame 1806, a circuit board 1807 and a battery 1808, between an upper cover 1801 and a lower cover 1809. The touch panel 1803 and the display panel 1805 are connected to flexible printed circuits FPCs 1802, 1804. Transistors are printed on the circuit board 1807. The battery 1808 may be omitted if the display device is not a portable device; even if the display device is a portable device, the battery 1808 may be provided at a different position.

The display device 1800 may have red, green and blue color filters. The color filters may be disposed in a delta arrangement of the above red, green and blue.

The display device 1800 may be used as a display unit of a mobile terminal. In that case the display device 1800 may have both a display function and an operation function. Mobile terminals include mobile phones such as smartphones, tablets and head-mounted displays.

The display device 1800 may be used in a display unit of an imaging device that has an optical unit having a plurality of lenses, and that has an imaging element which receives light having passed through the optical unit. The imaging device may have a display unit that displays information acquired by the imaging element. The display unit may be a display unit exposed outside the imaging device, or may be a display unit disposed within a viewfinder. The imaging device may be a digital camera or a digital video camera.

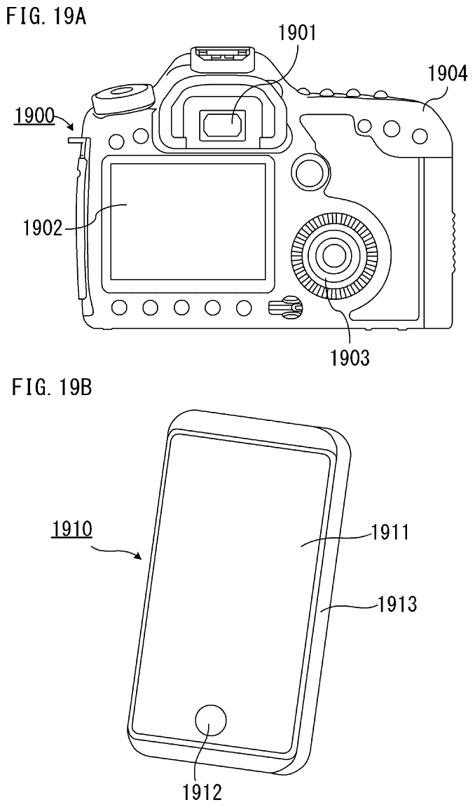

FIG. 19A illustrates a schematic diagram depicting an example of an imaging device according to the present embodiment. An imaging device 1900 may have a viewfinder 1901, a rear display 1902, an operation unit 1903 and a housing 1904. The viewfinder 1901 may have the display device according to the present embodiment. In that case the display device may display not only an image to be captured, but also for instance environment information and imaging instructions. The environment information may include for instance external light intensity, external light orientation, the moving speed of a subject, and the chance of the subject being blocked by an obstacle.

The timing suitable for imaging is short, and hence information should be displayed as soon as possible. It is therefore preferable to configure the display device so as to have high response speed, using the organic light-emitting element of the present embodiment. A display device that utilizes the organic light-emitting element can be utilized more suitably than these devices or liquid crystal display devices, where high display speed is required.

The imaging device 1900 has an optical unit, not shown. The optical unit has a plurality of lenses, and forms an image on an imaging element accommodated in the housing 1904. The lenses can be focused through adjustment of the relative positions thereof. This operation can also be performed automatically. The imaging device may be referred to as a photoelectric conversion device. The photoelectric conversion device can encompass, as an imaging method other than sequential imaging, a method that involves detecting a difference relative to a previous image, and a method that involves cutting out part of a recorded image.

FIG. 19B is a schematic diagram illustrating an example of an electronic device according to the present embodiment. An electronic device 1910 includes a display unit 1911, an operation unit 1912, and a housing 1913. The housing 1913 may have a circuit, a printed board having the circuit, a battery, and a communication unit. The operation unit 1912 may be a button, or a touch panel-type reaction unit. The operation unit may be a biometric recognition unit which for instance performs unlocking upon recognition of a fingerprint. The electronic device having a communication unit can also be referred to as a communication device. The electronic device 1910 may further have a camera function, by being provided with a lens and an imaging element. Images captured by way of the camera function are displayed on the display unit. Examples of the electronic device include smartphones and notebook computers.

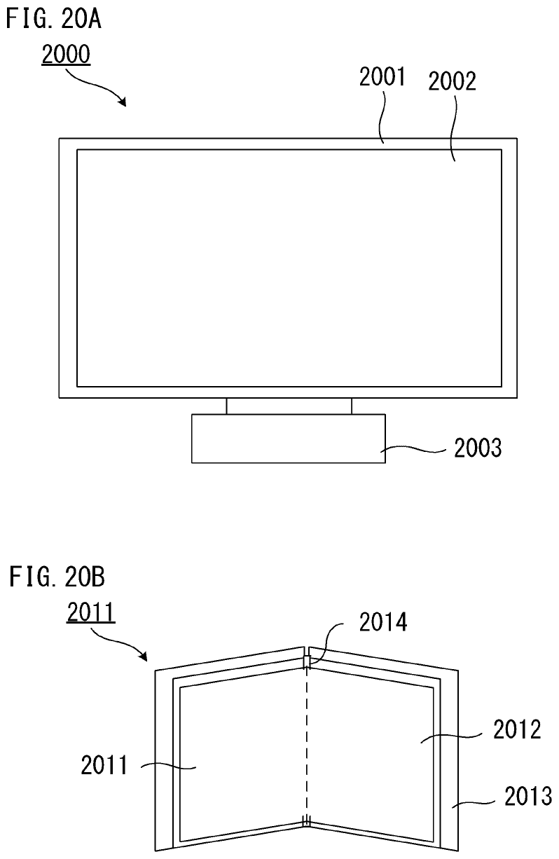

Next, FIG. 20A illustrates a schematic diagram depicting an example of a display device having the organic light-emitting element according to the present embodiment. FIG. 20A illustrates a display device 2000 such as a television monitor or PC monitor. The display device 2000 has a frame 2001 and a display unit 2002. The display unit 2002 may use the organic light-emitting element according to the present embodiment. The display device 2000 also has the frame 2001 and a base 2003 that supports the display unit 2002. The form of the base 2003 is not limited to the form in FIG. 20A. The lower side of the frame 2001 may also double as the base. The frame 2001 and the display unit 2002 may be curved. The radius of curvature of the foregoing may be at least 5000 mm and not more than 6000 mm.

FIG. 20B is a schematic diagram illustrating another example of a display device having the organic light-emitting element according to the present embodiment. A display device 2010 in FIG. 20B is a so-called foldable display device, configured to be foldable. The display device 2010 has a first display unit 2011, a second display unit 2012, a housing 2013 and a folding point 2014. The first display unit 2011 and the second display unit 2012 may have the organic light-emitting element according to the present embodiment. The first display unit 2011 and the second display unit 2012 may be one seamless display device. The first display unit 2011 and the second display unit 2012 can be separated at the folding point. The first display unit 2011 and the second display unit 2012 may display different images; alternatively, the first display unit and the second display unit may display one image.

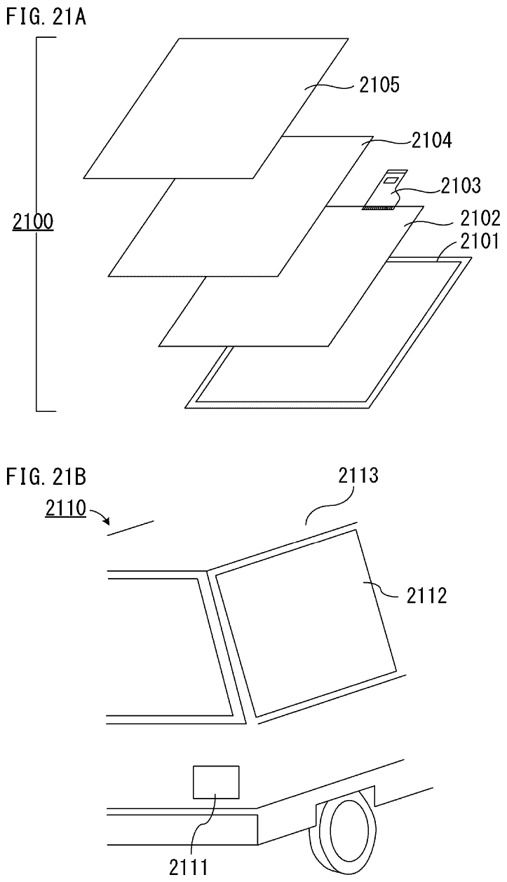

FIG. 21A illustrates next a schematic diagram depicting an example of a lighting device having the organic light-emitting element according to the present embodiment. A lighting device 2100 may have a housing 2101, a light source 2102, a circuit board 2103, an optical film 2104 and a light-diffusing part 2105. The light source has the organic light-emitting element according to the present embodiment. The optical film may be a filter that enhances the color rendering of the light source. The light-diffusing part allows effectively diffusing light from the light source, and allows delivering light over a wide area, for instance in exterior decorative lighting. The optical filter and the light-diffusing part may be provided on the light exit side of the lighting device. A cover may be provided on the outermost part, as the case may require.

The lighting device 2100 is for instance a device for indoor illumination. The lighting device may emit white, daylight white, or other colors from blue to red. The lighting device may have a light control circuit for controlling light having the foregoing emission colors. The lighting device 2100 may have the organic light-emitting element according to the present embodiment, and a power supply circuit connected thereto. The power supply circuit is a circuit that converts AC voltage to DC voltage. White denotes herein a color with a color temperature of 4200 K, and daylight white denotes a color with a color temperature of 5000 K. The lighting device 2100 may have a color filter.

The lighting device 2100 may have a heat dissipation part. The heat dissipation part dumps, out of the device, heat from inside the device; the heat dissipation part may be made up of a metal or of liquid silicone rubber, exhibiting high specific heat.

FIG. 21B is a schematic diagram of an automobile, which is an example of a moving body having the organic light-emitting element according to the present embodiment. The automobile has tail lamps, being an example of a lamp. The automobile 2110 may have a tail lamp 2111, of a form such that the tail lamp is lit up when for instance a braking operation is performed.

The tail lamp 2111 has the organic light-emitting element according to the present embodiment. The tail lamp may have a protective member that protects the organic light-emitting element. The protective member may be made up of any material, so long as the material has a certain degree of high strength and is transparent; the protective member is preferably made up of polycarbonate or the like. For instance, a furandicarboxylic acid derivative or an acrylonitrile derivative may be mixed with the polycarbonate.

The automobile 2110 may have a vehicle body 2113, and a window 2112 attached to the vehicle body 2113. The window may be a transparent display, unless the purpose of the window is to look ahead and behind the automobile. The transparent display may have the organic light-emitting element according to the present embodiment. In that case, constituent materials such as the electrodes of the organic light-emitting element are made up of transparent members.

The moving body having the organic light-emitting element according to the present embodiment may be for instance a vessel, an aircraft or a drone. The moving body may have a body frame and a lamp provided on the body frame. The lamp may emit light for indicating the position of the body frame. The lamp has the organic light-emitting element according to the present embodiment.

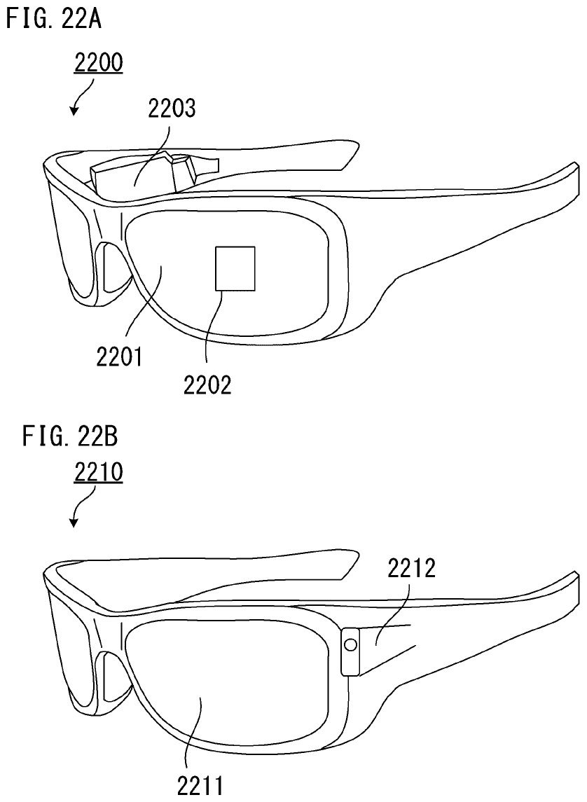

A display device according to an embodiment of the present invention is described with reference to FIGS. 22A and 22B. The display device having the organic light-emitting element of the present embodiment can be used in a system that can be worn as a wearable device, such as smart glasses, HMDs or smart contacts. An imaging display device used in such an application example may have an imaging device capable of photoelectrically converting visible light, and a display device capable of emitting visible light.

FIG. 22A illustrates spectacles 2200 (smart glasses) according to an application example of the display device of the present embodiment. An imaging device 2202 such as a CMOS sensor or a SPAD is provided on the front surface side of a lens 2201 of the spectacles 2200. A display device of the embodiments described above is provided on the back surface side of the lens 2201.

The spectacles 2200 further have a control device 2203. The control device 1603 functions as a power supply that supplies power to the imaging device 2202 and to the display device according to the embodiments. The control device 2203 controls the operations of the imaging device 2202 and of the display device. The lens 2201 has formed therein an optical system for condensing light onto the imaging device 2202.

FIG. 22B illustrates spectacles 2210 (smart glasses) according to another application example of the display device having the organic light-emitting element of the present embodiment. The spectacles 2210 have a control device 2212. The control device 2212 has mounted therein an imaging device corresponding to the imaging device 2202, and a display device. In a lens 2211 there is formed an optical system for projecting the light emitted by the display device in the control device 2212, such that an image is projected onto the lens 2211. The control device 2212 functions as a power supply that supplies power to the imaging device and to the display device, and controls the operations of the imaging device and of the display device. The control device may have a line-of-sight detection unit that detects the line of sight of the wearer. Infrared rays may be used herein for line-of-sight detection. An infrared light-emitting unit emits infrared light towards one eyeball of a user who is gazing at a display image. The infrared light emitted is reflected by the eyeball, and is detected by an imaging unit having a light-receiving element, whereby a captured image of the eyeball is obtained as a result. Impairment of the appearance of the image is reduced herein by having a reducing means for reducing light from the infrared light-emitting unit to the display unit, in a plan view.

The line of sight of the user with respect to the display image is detected on the basis of the captured image of the eyeball obtained through infrared light capture. Any known method can be adopted for line-of-sight detection using the captured image of the eyeball. As an example, a line-of-sight detection method can be resorted to that utilizes Purkinje images obtained through reflection of irradiation light on the cornea.

More specifically, line-of-sight detection processing based on a pupillary-corneal reflection method is carried out herein. The line of sight of the user is detected by calculating a line-of-sight vector that represents the orientation (rotation angle) of the eyeball, on the basis of a Purkinje image and a pupil image included in the captured image of the eyeball, in accordance with a pupillary-corneal reflection method.

The display device having the organic light-emitting element according to the present embodiment may have an imaging device having a light-receiving element, and may control the display image of the display device on the basis of line-of-sight information about the user, from the imaging device.

Specifically, a first visual field area gazed at by the user and a second visual field area, other than the first visual field area, are determined in the display device on the basis of line-of-sight information. The first visual field area and the second visual field area may be determined by the control device of the display device; alternatively, the display device may receive visual field areas determined by an external control device. In a display area of the display device, the display resolution in the first visual field area may be controlled to be higher than the display resolution in the second visual field area. That is, the resolution in the second visual field area may set to be lower than that of the first visual field area.

The display area may have a first display area and a second display area different from the first display area, such that the display device selects the area of higher priority, from among the first display area and the second display area, on the basis of the line-of-sight information. The first display area and the second display area may be determined by the control device of the display device; alternatively, the display device may receive display areas determined by an external control device. The display device may control the resolution in a high-priority area so as to be higher than the resolution in areas other than high-priority areas. That is, the display device may lower the resolution in areas of relatively low priority.

Herein, AI (Artificial Intelligence) may be used to determine the first visual field area and high-priority areas. The AI may be a model constructed to estimate, from an image of the eyeball, a line-of-sight angle, and the distance to an object lying ahead in the line of sight, using training data in the form of the image of the eyeball and the direction towards which the eyeball in the image was actually gazing at. An AI program may be provided in the display device, in the imaging device, or in an external device. In a case where an external device has the AI program, the AI program is transmitted to the display device via communication from the external device.

In a case where the display device performs display control on the basis of on visual recognition detection, the display device can be preferably used in smart glasses further having an imaging device that captures images of the exterior. The smart glasses can display captured external information in real time.

The present invention provides an accurate inspection apparatus that enables low-cost, quick detection of defects without using sensor defect data.

### Other Embodiments

The present invention can also be implemented by executing the following processes, i.e., of supplying application software (program) that implements the functions of the embodiment described above to a system or apparatus via a network or by means of various storage media, and reading and executing the program by a computer (or CPU or MPU) of the system or apparatus.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-178906, filed on Oct. 17, 2023, which is hereby incorporated by reference herein in its entirety.

What is claimed is:

1. An inspection apparatus for defect detection in a display device having an array of a plurality of pixels, comprising:
a processor; and
a memory storing a program which, when executed by the processor, causes the inspection apparatus to:
perform an image acquisition processing to acquire an image of the pixels of the display device with sensor pixels;
perform a locating processing to locate positions of defect candidates of the display device in the image captured by the image acquisition processing;
perform a contour generation processing to generate a contour of the defect candidate of the display device based on the position of the defect candidate of the display device; and
perform a determination processing to determine whether the defect candidate is a defect of the display device based on a perimeter of the contour.

2. The inspection apparatus for defect detection according to claim 1, wherein the determination processing distinguishes a defect in the display device from a defect in the sensor pixels based on a size of a defect contained in the image acquired by the image acquisition processing.

3. The inspection apparatus for defect detection according to claim 1, wherein the image acquisition processing acquires an image of one of the plurality of pixels of the display device using a plurality of sensor pixels.

4. The inspection apparatus for defect detection according to claim 1, wherein the determination processing obtains a defect determination threshold, compares the perimeter of the contour generated by the contour generation processing with the defect determination threshold, and determines whether the defect candidate is a defect in the display device based on a result of the comparison.

5. The inspection apparatus for defect detection according to claim 4, wherein the defect determination threshold is a perimeter of a contour of one pixel of the display device in the image acquired by the image acquisition processing.

6. The inspection apparatus for defect detection according to claim 4, wherein the defect determination threshold is a perimeter of a contour allowing the determination processing to detect a defect of a visible size.

7. The inspection apparatus for defect detection according to claim 1, wherein the determination processing obtains a defect determination threshold, and determines that the defect candidate is a defect in the display device when the perimeter of the contour is equal to or more than the defect determination threshold.

8. The inspection apparatus for defect detection according to claim 1, the program further causes the inspection apparatus to:
perform a notification processing to provide a notification of a result of determination of a defect in the display device by the determination processing.

9. The inspection apparatus for defect detection according to claim 8, wherein the notification processing provides a notification that the image acquired by the image acquisition processing contains a defect in the display device or a defect in the sensor pixels.

10. The inspection apparatus for defect detection according to claim 1, wherein the locating processing generates a binarized image that indicates the position of the defect candidate based on a result of comparison between pixel values of the sensor pixels and a feature calculated from pixel values of surrounding sensor pixels.

11. The inspection apparatus for defect detection according to claim 10, wherein the locating processing calculates the feature using a median filter.

12. The inspection apparatus for defect detection according to claim 10, wherein the locating processing calculates the feature using a mean filter.

13. The inspection apparatus for defect detection according to claim 10, wherein the locating processing performs complementation on a pixel value between pixels of the binarized image.

14. The inspection apparatus for defect detection according to claim 1, wherein the sensor pixels have a pixel size that is one ninth or less of a pixel size of the display device.

15. A method of manufacturing organic light-emitting devices comprising the steps of:
acquiring an image, with sensor pixels, of a plurality of pixels that are organic light-emitting devices arrayed in a display device;
locating a position of a defect candidate of the display device in the image captured in the image acquisition step;
generating a contour of the defect candidate of the display device based on the position of the defect candidate of the display device; and
determining whether the defect candidate is a defect of the display device based on a perimeter of the contour.

16. A display device comprising a plurality of pixels,
at least one of the plurality of pixels comprising an organic light-emitting device manufactured by the method according to claim 15, and a transistor connected to the organic light-emitting device.

17. An optoelectronic apparatus comprising:
an optical unit including a plurality of lenses;
an imaging device receiving light that has passed through the optical unit; and
a display unit that displays an image captured by the imaging device,
the display unit including an organic light-emitting device manufactured by the method according to claim 15.

18. An electronic device comprising:
a display unit including an organic light-emitting device manufactured by the method according to claim 15;
a housing provided with the display unit; and
a communication unit provided to the housing for communication with external equipment.

19. An illumination apparatus comprising:
a light source including an organic light-emitting device manufactured by the method according to claim 15; and
a light-diffusing part or an optical film that transmits light emitted from the light source.

20. A moving body comprising:
a lamp including an organic light-emitting device manufactured by the method according to claim 15; and
a body frame provided with the lamp.
